(19) United States
(12) Patent Application Publication
(10) Pub. No.: US 2012/0160536 A1
(43) Pub. Date: Jun. 28, 2012

(54) FLUID CONNECTOR WITH HOSE CUTTING RING

(76) Inventor: Mike Beining, Holland, OH (US)

(21) Appl. No.: 12/977,521

(22) Filed: Dec. 23, 2010

(51) Int. Cl. H01B 7/00; F16L 33/00

(52) U.S. Cl. 174/47; 285/18

(57) ABSTRACT

An electrically conductive hose cutting ring is shaped to provide a cutting edge for penetration of the inner layer(s) of a multiple layer fluid conveyance hose when it is forced onto a fluid connector. The cutting action by the cutting blade provides for a relatively low resistance electrical connection between an electrically conductive layer of the hose and the fluid connector. This can be used to provide a signal path from a sensing element on the hose to a system electronic component.

### RELATED APPLICATIONS

The present application relates to application Atty. Ref. No. 66777-0076 U.S. Ser. No. ______, entitled Fluid Connector with a Hose Cutting Clip and to application Atty. Ref. No. 65857-0194, U.S. Ser. No. ______, entitled Fluid Connector with Hose Cutting Blades, both of which were filed on the same day as this application.

### BACKGROUND

Traditionally, a hose that is to be connected to a system device such as a hydraulic pump is first connected to some type of hose fitting such as a fluid connector having a barbed nipple for connection to a fluid conveyance hose. The fluid connector is then typically connected to some type of device such as a pump or valve block using a connector nut. As the hose is forced over the barbs on the nipple, the barbs apply a retaining force by displacing the inner layer of the hose outward without cutting that inner layer. If there is a need for an electrical connection between an electrically conductive intermediate layer of the hose and an electronic system, then a jumper wire is required to be routed from the electrically conductive intermediate layer to the fluid connector or directly to the electronic system or to some type of fluid device to which the fluid connector is attached. These prior art electrical jumpers are unreliable and are expensive to assemble and are susceptible to damage either during assembly or during operation.

### SUMMARY

The present disclosure describes a fluid connector that includes a hose cutting ring that has a disc shape that surrounds the body of the fluid connector. In an alternative embodiment, the hose cutting ring has material removed to form at least one sharp cutting blade that extends from the ring body. The hose cutting ring provide a cutting function when a fluid conveyance hose, having a pliable inner layer which covers an electrically conductive layer, is installed onto the fluid connector. The inner layer of the hose is cut by the cutting ring so that there is an electrical path from the intermediate electrically conductive layer of the hose to the fluid connector and finally to the device to which the fluid connector is attached or, in the alternative, directly from the fluid connector to an electrical circuit. The hose cutting ring of this disclosure is particularly suitable for use in conjunction with a hose that incorporates some type of sensing element in the hose such as a life sensing hose. The signal generated by the sensor must be carried by the electrically conductive layer of the hose through a fluid fitting or connector to a device where it is made available for use by other control or diagnostic systems.

The hose cutting ring has a sharp edge and is shaped like a disc with an aperture in the center which surrounds the body of the fluid connector. This hose cutting ring provides a cutting function when the hose is fully installed onto the fluid connector such that the inner layer of a hose is cut by at least one of the cutting ring so that there is an electrical path from the intermediate electrically conductive layer of the hose to a fluid connector and finally to the device to which the fluid connector is connected or from the fluid connector directly to an electronic circuit such as an electronic diagnostic or control system. The conductive layer of the hose is usually a steel braid, spiral wound or knitted layer.

Also disclosed is another embodiment where a connector socket that has cutting tabs extending inwardly is used with hoses having a second electrically conductive layer and an intermediate non-conductive layer that separates the first conductive layer from the second conductive layer. The cutting tabs which extend inwardly from an inside surface of a hose socket and cut into the outer layer of the hose and penetrate down to touch and slightly deform the second conductive layer. This completes the electrically conductive path from the second conductive layer to the socket. The socket is electrically insulated from the connector body by an insulator collar. In the case where higher fluid pressures need to be handled by the fluid connector and attached hose, this type of a crimped socket can be used to apply additional clamping force on the outside of the hose over the hose nipple.

### BRIEF DESCRIPTION OF THE DRAWINGS

FIG. 1 is a cross-sectional view of a fluid connector assembly having the exemplary hose cutting ring with a hose just prior to installation on the fluid connector;

FIG. 2 is a cross-sectional view of the fluid connector assembly of FIG. 1 with a fluid conveyance hose installed; and

FIG. 3 is cross-sectional view 3-3 of an alternate embodiment of the exemplary cutting ring formed on an exemplary fluid connector.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

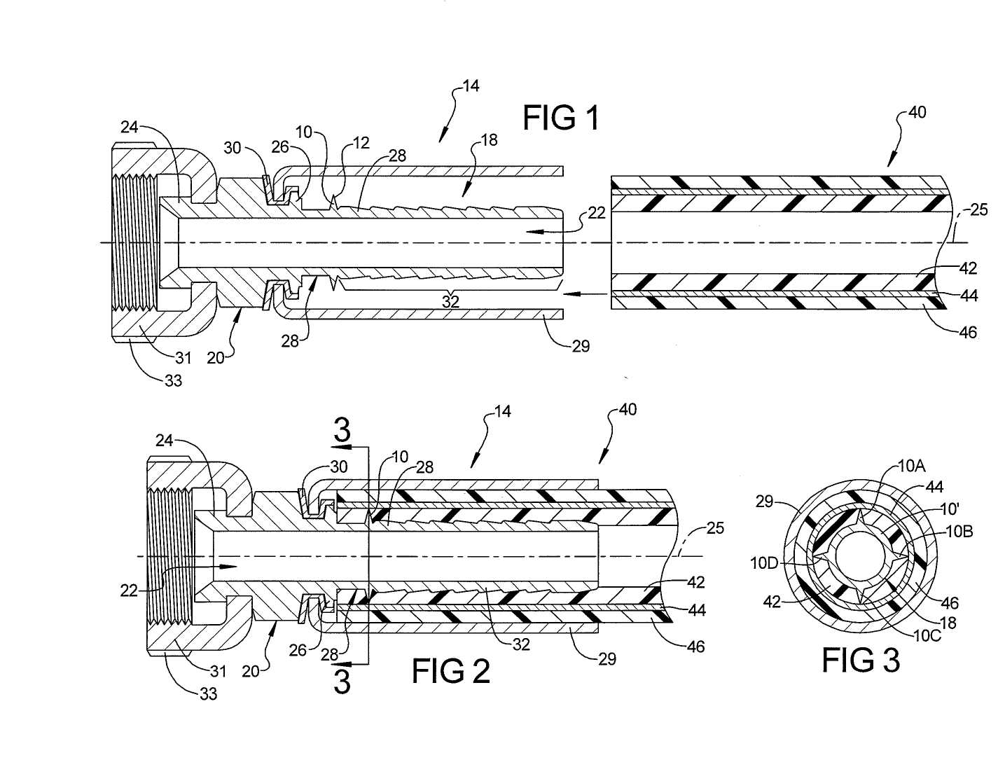

Now referring to FIG. 1 of the drawings, a top plan view of the exemplary fluid connector 14 is shown having a cutting ring 10. The cutting ring 10 extends from the body 20 of the fluid connector 14. The hose cutting ring 10 has a cylindrical shape and has a sharp edge 12. The cutting ring 10 can be formed or machined as part of the fluid connector 14 or it can be made as a separate piece that is slipped onto the mounting section 28 and then fastened to the body 20 by welding or other bonding method.

The cutting ring 10 has a sharp edge 12 and is shown generally as triangular in cross-section but other shapes could be used depending on a variety of factors. For example, the sharp edge 12 of the cutting ring 10 can be segmented to form individual cutting elements, an example of with is shown in FIG. 3 as cutting needles 10A, 10B, 10C and 10D. Other shapes other than a needle shape can be used such as a square like tab. Irregardless of the shape of the cutting ring 10, the edge of the cutting ring 10 must penetrate the inner layer of a fluid conveyance hose to reach an electrically conductive layer of the hose. The intermediate flange 26 locates the cutting ring 10 at one side of the ring body 20 while a first barb 28 serves to locate the other side of the cutting ring 10 on the ring holding section 21 of the fluid connector 18. The cutting ring 10 can be removable or permanently attached to the body 12 of the fluid connector 18 or alternately, the cutting ring 10 can be formed as an integral part of the body 12 of the fluid connector 18. In that configuration, the cutting ring 10 would extend from the body 12 to cut the inner layer 42 of the hose 40 and electrically engage the conductive intermediate layer 44.

The hose cutting ring 10 provides a cutting function when the inner layer 42 of the hose 40 is cut by the cutting ring 10 to touch the inner electrically conductive layer 44 of the hose 40 and there is an electrical path established from this conductive layer 44 of the hose 40 to the fluid connector 18 and finally to the device to which the fluid connector 18 is attached such as to a hydraulic pump, motor, valve body, etc. or directly to the electronic circuit of a diagnostic or control system. The hose cutting ring 10 of this disclosure is particularly suitable for use in a hose 40 that incorporates some type of sensing element in the hose 40 such as a life sensing hose which generates an electrical signal which must be carried by the hose 40 through a fluid connector 18 to a device where it is made available for use by a control or diagnostic system. The mating fluid conveyance hose 40 is retained on the fluid connector 18 by at least one barb such as first barb 28 or by a multiplicity of hose barbs donated as barbed nipple 32. The barbed nipple 32 of the fluid connector 18 makes up what is known in the art as the hose nipple of the fluid connector 18 and it is known to use the nipple to retain a fluid conveyance hose.

The fluid connector 18 has a hex nut 20 which is fashioned to be engaged by a tool such as a wrench to hold the fluid connector 18 from rotating as the coupler nut 31 is tightened to a mating threaded fitting on a fluid device such as a pump or valve body. A central passageway 22 formed along a central axis 24 of the fluid connector 18 provides a path to allow a pressurized fluid to flow there through. A circumferential intermediate flange 26 extends outwardly from the body of the fluid connector 18 and positions the insulating collar 36. Also shown is the hose socket 29 which is mounted on the flange 26 with the insulating collar 36 positioned between the hose socket 29 and the flange 26 if electrical insulation is needed between the socket 29 and the fluid connector 18. This is typically the case when the outside layer 46 of the hose 40 is skived and a hose conductive layer is allowed to make electrical contact with the socket 29 with a subsequent electrical connection to an electronic circuit. Generally, the hose socket 29 is an optional part that is used for use with the handling of higher pressure fluids. It should be noted, if a socket 29 is used and no electrical insulation is required, then the insulating collar 36 can be eliminated. The connector nut 31 is used to attach the fluid connector 18 to another fluid handling device such as a pump or valve body. The intermediate flange 26 locates the cutting ring 10 at one side of the ring body 20 while a first barb 28 serves to locate the other side of the cutting ring 10 on the ring holding section 21 of the fluid connector 18.

The hose 40 is shown as being made of an inner layer 42, an electrically conductive intermediate layer 44 and a wear resistant outer layer 46. It should be noted that any number of layers beyond an inner layer 42 and an intermediate conductive layer 44 can be used for the hose. The inner layer 42 can be made of a PTFE or other chemically impervious material and can consist of more than one layer while the intermediate layer 44 is usually a braided or spiral or knitted steel wire although other electrically conductive material or configuration could be used such as a foil or carbon fiber. Then other hose layers can be added as required for a specific application.

If the hose 40 has at least a first conductive layer 44 and it is desired to make an electrical connection between the conductive layer 44 and the hose socket 29, then the outer layer 46 of the hose 40 can be skived to the conductive layer 44 so that the socket 29 having a smooth inner surface can contact the conductive layer 44 when it is crimped to the hose 40. This configuration would create an electrical path from the conductive layer 44 in the hose 40 to the hose socket 29. This electrical signal could then be used by a variety of electrical circuits.

A chamfered section 25 is formed to engage a mating element formed in a hydraulic device such as a pump body to provide a sealed path for the fluid. The connector nut 31 is threaded on the internal face of the connector nut 31. The threads 29 engage mating threads formed in the pump body or other hydraulic device where the connector nut 31 can be rotated and tightened to the hydraulic device by hex section 33 to draw the chamfered section 24 into the mating element of the hydraulic device.

Attached to the body 20 at the insulating collar 36 is a hose socket 29. The hose socket 29 is supported on the insulating collar 36 and surrounds and is crimped to the hose 40. The hose socket 29 is crimped onto the hose to provide a clamping force on the hose 40 to force it against the nipple 32. The insulating collar 36 can locate and hold a prior art type of socket 29 having a smooth inner surface if it used with a hose only having a single conductive layer. The connector socket 29 is shown in FIG. 4 as a smooth bore version of connector socket 29. With this version, if it is desired to have electrical conduction between the hose conductive layer 44 and the socket 29, then the outer layer 46 of hose 40 can be skived off so that the inner surface of the socket 29 makes contact with the conductive layer 44 of the hose 40.

Now referring to FIG. 2 of the drawings, a cross-sectional view of the hose 40 fully installed on the fluid connector 18 is shown. Clearly shown is how the cutting ring 10 has sliced through the hose inner layer 42 to extend and make mechanical and electrical contact with the electrically conductive layer 44 thereby establishing a secure electrical path from the electrically conductive layer 44 to the cutting ring 10 and to the fluid connector 18. This type of hose connection device is used to provide conduction of an electrical signal representing a hose performance state or internal fluid pressure to some type of electronic circuitry.

The exemplary cutting ring 10 has a ring body 20 that extends in a ring like fashion outwardly from the ring body 20. The cutting ring 10 is installed on the body of the fluid connector 18 or it is formed as an integral part of the fluid connector 18. The hose cutting ring 10 provides a cutting function when the inner layer 42 of the hose 40 is cut by the cutting ring 10 to touch the inner electrically conductive layer 42 of the hose 40 and there is an electrical path established from this inner conductive layer 42 of the hose 40 to the fluid connector 18 and finally to the device to which the fluid connector 18 is attached such as to a hydraulic pump, motor, valve body, etc. or directly to the electronic circuit of a diagnostic or control system. The hose cutting ring 10 of this disclosure is particularly suitable for use in a hose 40 that incorporates some type of sensing element in the hose 40 such as a life sensing hose which generates an electrical signal which must be carried by the hose through a fluid connector 18 to a device where it is made available for use by a control or diagnostic system.

The fluid connector 18 has a hex nut 20 which is fashioned to be engaged by a tightening tool such as a wrench to hold the fluid connector 18 from rotating as the fluid connector 18 is attached to some type of hydraulic device such as a pump. The connector nut 31 is rotated to tighten the chamfer connector 24 to a mating surface on the hydraulic device. The internal threads 29 engage mating threads formed on the hydraulic (or pneumatic) device when the connector nut 31 is rotated by the nut hex 33. A central passageway 22 formed along a central axis 25 of the fluid connector 18 provides a flow path to allow a pressurized fluid to flow there through. A circumferential intermediate flange 26 extends outwardly from the body 12 of the fluid connector 18 and helps to position the insulating collar 36. The intermediate flange 26 locates the cutting ring 10 at one side of the ring body 20 while a first barb 28 serves to locate the other side of the cutting ring 10 on the ring body 20.

The mating hose is retained on the fluid connector 18 by at least one barb such as first barb 28 or by a multiplicity of hose barbs donated as barbed section 32. The barbed section 32 of the fluid connector 18 makes up what is known as the nipple of the fluid connector 18.

The hose 40 is shown as being made of an inner layer 42, an electrically conductive intermediate layer 44 and a wear resistant outer layer 46. It should be noted that any number of layers beyond an inner layer 42 and an intermediate conductive layer 44 can be used for the hose. The inner layer 42 can be made of a PTFE or other chemically impervious material and can consist of more than one layer while the intermediate layer 44 is usually a braided or spiral or knitted steel wire although other electrically conductive material or configuration could be used such as a foil or carbon fiber. Then other hose layers can be added as required for a specific application.

If the hose 40 has at least a first conductive layer 44 and it is desired to make an electrical connection between the conductive layer 44 and the hose socket 29, then the outer layer 46 of the hose 40 can be skived to the conductive layer 44 so that the socket 29 having a smooth inner surface can contact the conductive layer 44 when it is crimped to the hose 40. This configuration would create an electrical path from the conductive layer 44 in the hose 40 to the hose socket 29. This electrical signal could then be used by a variety of electrical circuits.

If the hose 40 has two conductive layers, then the first conductive layer can be electrically connected to the cutting ring 10 of the cutting ring 10 and the second conductive layer can be electrically connected to the socket 29 by skiving the hose outer layer 46 to expose it to the socket 29 when the socket 29 is crimped.

Now referring to FIG. 3 of the drawings, a cross-sectional view 3-3 of the fluid connector 14 of FIG. 2 is shown with an alternate embodiment of the cutting ring 10′. The cutting ring 10′ has been formed from the previous described cutting ring 10 by removing material from the cutting ring 10 to form four cutting needles 10A, 10B, 10C and 10D. Any number of cutting needles could be formed. Also, other shapes such as square tabs could be formed by segmenting the cutting ring 10. At least one of the cutting needles 10A-10D is used to penetrate and cut the inner layer 42 of the hose 40 to make electrical contact with the electrically conductive layer 44.

The hose 40 is shown as being made of an inner layer 42, an electrically conductive intermediate layer 44 and a wear resistant outer layer 46. It should be noted that any number of layers beyond an inner layer 42 and an intermediate conductive layer 44 can be used for the hose. The inner layer 42 can be made of a PTFE or other chemically impervious material and can consist of more than one layer while the intermediate layer 44 is usually a braided or spiral or knitted steel wire although other electrically conductive material or configuration could be used such as a foil or carbon fiber. Then other hose layers can be added as required for a specific application.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

We claim:

1. A fluid connector having at least one cutting ring attached to a body section of the fluid connector where the cutting ring extends so as to cut at least the inner layer of an installed hose and then contacting a conductive layer of the hose.

2. The fluid connector of claim 1, wherein said cutting ring is attached and extends from a cutting ring.

3. The fluid connector of claim 2 where the cutting ring is comprised of a ring body that engages said body section of the fluid connector.

4. A method of providing electrical connection between a hose conductive layer and a fluid connector comprising;
providing a cutting ring having a cutting edge;
attaching said cutting ring to said fluid connector;
providing a hose having and inner layer and an adjacent conductive layer;
installing said hose on said fluid connector such that said cutting ring cuts into said inner layer and makes electrical contact with said conductive layer of said hose.

5. A method of providing electrical connection between a hose conductive layer and a fluid connector having a fluid connector body and a socket comprising;
providing a cutting ring having a cutting edge attached to said fluid connector body;
providing a hose having an inner layer and a first conductive layer and an intermediate layer and a second conductive layer and an outer layer;
installing said hose on said fluid connector such that said cutting ring cuts into said hose inner layer and makes electrical contact with said conductive layer of said hose; and
skiving said second layer so that said second conductive layer contacts said socket.

6. A method of providing electrical connection between a hose conductive layer and a fluid connector body comprising;
providing a cutting ring having a cutting edge, said cutting ring attached to said fluid connector body;
providing a hose having an inner layer and a first conductive layer and an intermediate layer and a second conductive layer and an outer layer; and
installing said hose on said fluid connector such that said cutting end cuts into said hose inner layer and makes electrical contact with said first conductive layer of said hose.

7. A cutting ring for a fluid connector where segments of said cutting ring are removed to form cutting elements.

8. The cutting ring of claim 7 wherein said cutting elements are cutting needles.

9. The cutting ring of claim 7 wherein said cutting elements are tabs.
